(19) United States
(12) Patent Application Publication
(10) Pub. No.: US 2026/0273946 A1
(43) Pub. Date: Sep. 17, 2026

(54) LIQUID CONTAINER

(71) Applicant: CANON KABUSHIKI KAISHA, Tokyo (JP)

(72) Inventors: NORIYASU NAGAI, Tokyo (JP); RYOJI INOUE, Kanagawa (JP)

(21) Appl. No.: 19/558,160

(22) Filed: Mar. 5, 2026

(30) Foreign Application Priority Data
Mar. 11, 2025 (JP) 2025-038334

(51) Int. Cl. B41J 2/175

(52) U.S. Cl. CPC B41J 2/17523; B41J 2/17509; B41J 2/17553; B41J 2/17596

(57) ABSTRACT

A liquid container includes a liquid storage portion configured to store a liquid inside, a nozzle having an outlet port for refilling a liquid ejection apparatus with the liquid stored in the liquid storage portion, an outer frame surrounding a tip side of the nozzle where the outlet port is formed, a shutter provided to the outer frame and capable of moving to a first position at which the shutter covers the outlet port and a second position at which the shutter exposes the outlet port, and a valve provided inside the nozzle and capable of opening and closing a liquid channel connected to the outlet port. In a case of connecting the liquid container to the liquid ejection apparatus, the shutter moves to the second position and the valve opens the liquid channel.

### BACKGROUND

### Field of the Technology

The present disclosure relates to a liquid container.

### Description of the Related Art

Some liquid ejection apparatuses, such as inkjet printing apparatuses, include liquid tanks storing liquids. Many of these liquid tanks are capable of being refilled with liquids using a liquid container prepared separately from these liquid tanks. The liquid container is capable of refilling a liquid tank with a liquid stored in the liquid container through a liquid passage to be connected to the liquid tank's inlet port. As such a liquid container, an ink supply container disclosed in Japanese Patent Laid-Open No. 2017-222152 (Literature 1), for example, is known. In the ink supply container disclosed in Literature 1, a valve having a slit or slits is provided in an ink outlet port of a container main body. In this way, the valve in the ink outlet port opens the slits in a case where an ink (liquid) is supplied, and the valve in the ink outlet port closes the slits in a case where the ink is not supplied. The valve provided in the ink outlet port of the container main body keeps the user's hand from touching the ink in the ink outlet port and thus prevents the ink from getting attached to and soiling the user's hand or the like.

However, in a case where the liquid container with the valve configured to open and close the slits is oriented downward at the time of supplying the liquid, the liquid accumulates inside the valve. Thus, there is a possibility that the ink leaks out through the slits in the valve and cause soiling. Also, in a case where the pressure inside the liquid container rises, there is a possibility that the liquid spurts out when the valve opens the slits, causing soiling.

### SUMMARY

The present disclosure is directed to a liquid container that does not cause soiling.

A liquid container according to some embodiments of the present disclosure is a liquid container to be connected to a liquid ejection apparatus to refill the liquid ejection apparatus with a liquid, the liquid container including: a liquid storage portion configured to store a liquid inside; a nozzle having an outlet port for refilling the liquid ejection apparatus with the liquid stored in the liquid storage portion; an outer frame surrounding a tip side of the nozzle where the outlet port is formed; a shutter provided to the outer frame and capable of moving to a first position at which the shutter covers the outlet port and a second position at which the shutter exposes the outlet port; and a valve provided inside the nozzle and capable of opening and closing a liquid channel connected to the outlet port. In a case of connecting the liquid container to the liquid ejection apparatus, the shutter moves to the second position and the valve opens the liquid channel.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an outer appearance of a liquid ejection apparatus.

FIG. 2 is a perspective view illustrating an internal configuration of the liquid ejection apparatus.

FIG. 3 is a perspective view illustrating an outer appearance of a liquid tank.

FIG. 4 is a side view illustrating an outer appearance of a liquid container according to a first embodiment.

FIG. 5 is a perspective view illustrating the tip side of the liquid container.

FIGS. 6A and 6B are side cross-sectional views illustrating the tip side of the liquid container.

FIG. 7 is a side cross-sectional view illustrating the tip side of the liquid container.

FIG. 8 is a schematic view illustrating an example of connection hole portions of the liquid ejection apparatus.

FIG. 9 is a perspective view illustrating a modification of the liquid container according to the first embodiment.

FIGS. 10A and 10B are views illustrating an outer appearance of a liquid container according to a second embodiment.

FIG. 11 is a cross-sectional view taken along the line XI-XI in FIG. 10A.

FIGS. 12A and 12B are side cross-sectional views illustrating the tip side of the liquid container according to the second embodiment.

### DESCRIPTION OF THE EMBODIMENTS

Various exemplary embodiments, features, and aspects of the present disclosure will be specifically described below with reference to the accompanying drawings. Note that the following embodiments do not limit the contents of the present disclosure, and not all of the combinations of the features described in the following embodiments are necessarily essential for the solution to be provided by the present disclosure. Note that identical components will be described with the same reference sign.

### First Embodiment

### Configuration of Liquid Ejection Apparatus

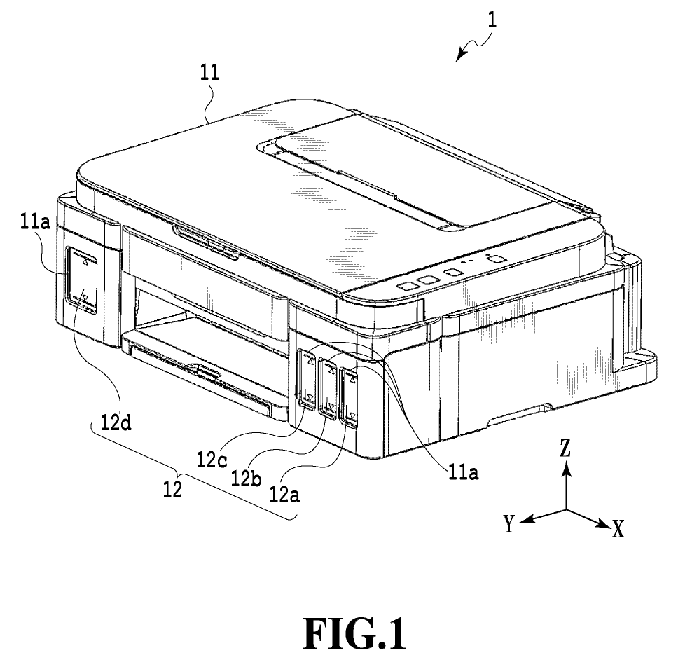

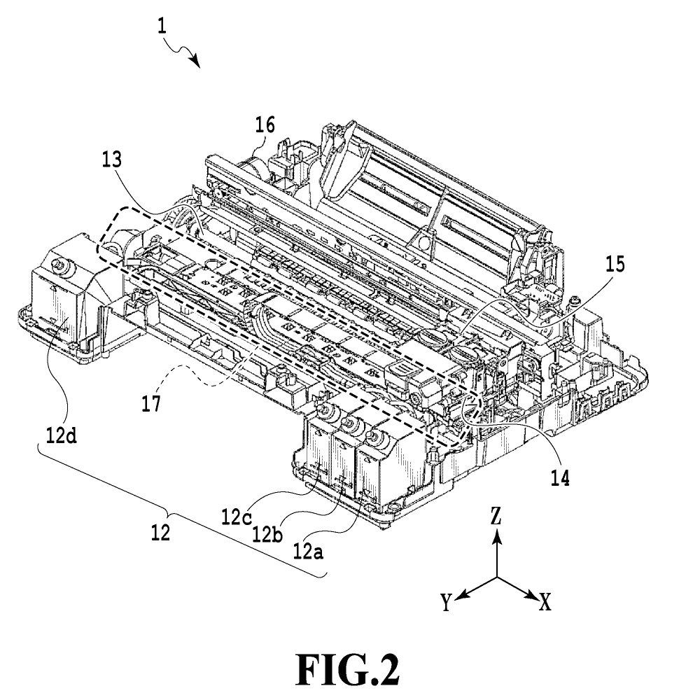

FIG. 1 is a perspective view illustrating an outer appearance of a liquid ejection apparatus 1 in the present embodiment. FIG. 2 is a perspective view illustrating an internal configuration of the liquid ejection apparatus 1 in the present embodiment. The liquid ejection apparatus 1 in the present embodiment is a serial inkjet printing apparatus. Note that, in drawings to be referenced below, the Z direction represents a vertical direction and intersects (in the present embodiment, orthogonally intersects) an X-Y plane defined by the X direction and the Y direction. As illustrated in FIGS. 1 and 2, the liquid ejection apparatus 1 includes a housing 11, a liquid tanks 12, a conveyance roller 13, a print head 14, a carriage 15, and a carriage motor 16.

The liquid tanks 12 is provided on the front side of the inside of the housing 11. The liquid tanks 12 store liquids to be ejected from the print head 14 onto a print medium (not illustrated). In the present embodiment, four types of inks (e.g., a cyan ink, a magenta ink, a yellow ink, and a black ink) are used as the liquids to be ejected from the print head 14. Accordingly, four liquid tanks 12a to 12d for the four types of inks are provided as the liquid tanks 12.

For example, the liquid tank 12a for the cyan ink stores the cyan ink to be supplied to the print head 14. The liquid tank 12b for the magenta ink stores the magenta ink to be supplied to the print head 14. The liquid tank 12c for the yellow ink stores the yellow ink to be supplied to the print head 14. The liquid tank 12d for the black ink stores the black ink to be supplied to the print head 14. Also, window portions 11a (see FIG. 1) are provided in a front wall portion of the housing 11. In this way, the four liquid tanks 12a to 12d provided inside the housing 11 are visible respectively through the window portions 11a from the front side (+Y side) of the liquid ejection apparatus 1.

The conveyance roller 13 is provided inside the housing 11. The conveyance roller 13 conveys a print medium in a conveyance direction extending along the Y direction. The conveyance roller 13 is capable of intermittently conveying a print medium by a predetermined pitch by being rotationally driven intermittently by a conveyance motor (not illustrated).

The print head 14 is mounted on the carriage 15. The print head 14 ejects liquids, such as inks, from ejection orifices (not illustrated). Note that the inks stored in the liquid tanks 12 are supplied to the print head 14 through liquid flow passages 17 and ejected from the ejection orifices of the print head 14. As described above, the print head 14 in the present embodiment is capable of ejecting four types of inks onto a print medium.

The carriage 15 and the carriage motor 16 are provided inside the housing 11. The carriage 15 is capable of reciprocally moving in a direction intersecting the conveyance direction of a print medium (X direction). The carriage motor 16 drives the carriage 15 on which the print head 14 is mounted. By driving the carriage 15 with the carriage motor 16, the print head 14 can be reciprocally moved in the direction intersecting the conveyance direction of the print medium (X direction).

The print medium is not particularly limited as long as images can be formed thereon with the liquids ejected from the print head 14. Examples of the print medium include paper, fabric, the label surface of an optical disk, a plastic sheet, an overhead projector (OHP) sheet, and so on.

The liquid ejection apparatus 1 repeats reciprocal movement (main scanning) of the print head 14 with the carriage motor 16 and conveyance of the print medium by the predetermined pitch with the conveyance roller 13 (sub scanning). The liquid ejection apparatus 1 selectively ejects multiple types of inks (liquids) from the print head 14 while synchronizing the main scanning and the sub scanning to print an image or the like on the print medium.

### Configuration of Liquid Tank

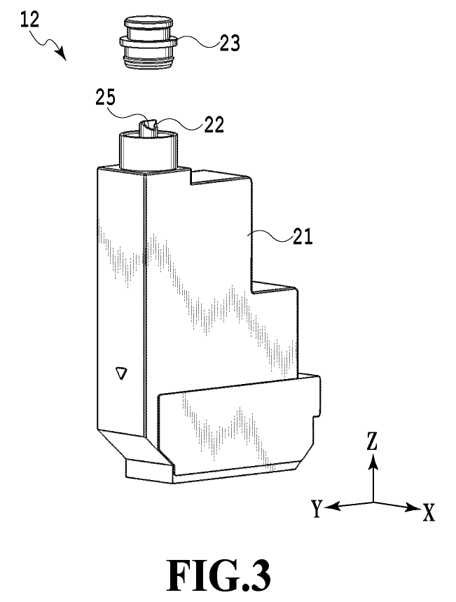

Next, a liquid tank 12 in the present embodiment will be described. FIG. 3 is a perspective view illustrating an outer appearance of a liquid tank 12 in the present embodiment. Note that the four liquid tanks 12a to 12d (see FIG. 1) for the four types of inks are configured similarly to the liquid tank 12 illustrated in FIG. 3. As illustrated in FIG. 3, the liquid tank 12 includes a liquid tank main body 21, a communication channel portion 22, and a tank cover 23.

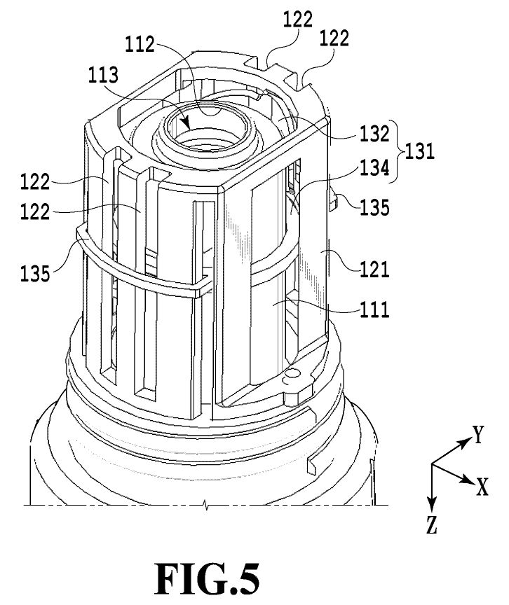

The liquid tank main body 21 is formed in a box shape having a liquid chamber (not illustrated) therein. The liquid tank main body 21 stores an ink (liquid) in the liquid chamber inside the liquid tank main body 21. The communication channel portion 22 is formed at an upper portion of the liquid tank main body 21 in such a way as to extend in the vertical direction (Z direction). The communication channel portion 22 communicates with the liquid chamber inside the liquid tank main body 21 and the outside of the liquid tank 12 (liquid tank main body 21). At a tip portion of the communication channel portion 22, an inlet port 25 to be connected to an outlet port 112 of a liquid container 100 (see FIG. 5 to be described later) is formed. The tank cover 23 is formed in a lid shape capable of covering the communication channel portion 22. The tank cover 23 is detachably attached to an upper portion of the liquid tank main body 21 to cover the communication channel portion 22. The tank cover 23 is attached to the upper portion of the liquid tank main body 21 in a case where the liquid tank 12 is not refilled with an ink. At this time, the tank cover 23 covers the communication channel portion 22, thus tightly closing the liquid chamber in the liquid tank main body 21. In a case of refilling the liquid tank 12 with an ink, the tank cover 23 is detached from the upper portion of the liquid tank main body 21.

In a case of refilling the liquid tank 12 with an ink, for example, the tank cover 23 is detached and separated from the upper portion of the liquid tank main body 21. Then, the communication channel portion 22 is inserted into the outlet port 112 of the liquid container 100 and the ink stored in the liquid container 100 is introduced from the inlet port 25 of the communication channel portion 22. After the introduction of the ink is finished, the communication channel portion 22 is pulled out of the outlet port 112 of the liquid container 100, and the tank cover 23 is attached to the upper portion of the liquid tank main body 21 to cover the communication channel portion 22. With the tank cover 23 covering the communication channel portion 22, the liquid chamber in the liquid tank main body 21 is tightly closed, thereby preventing evaporation of the ink from the liquid chamber.

### Configuration of Liquid Container

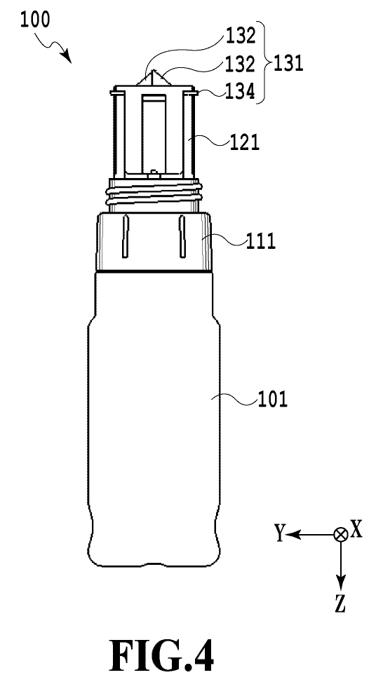

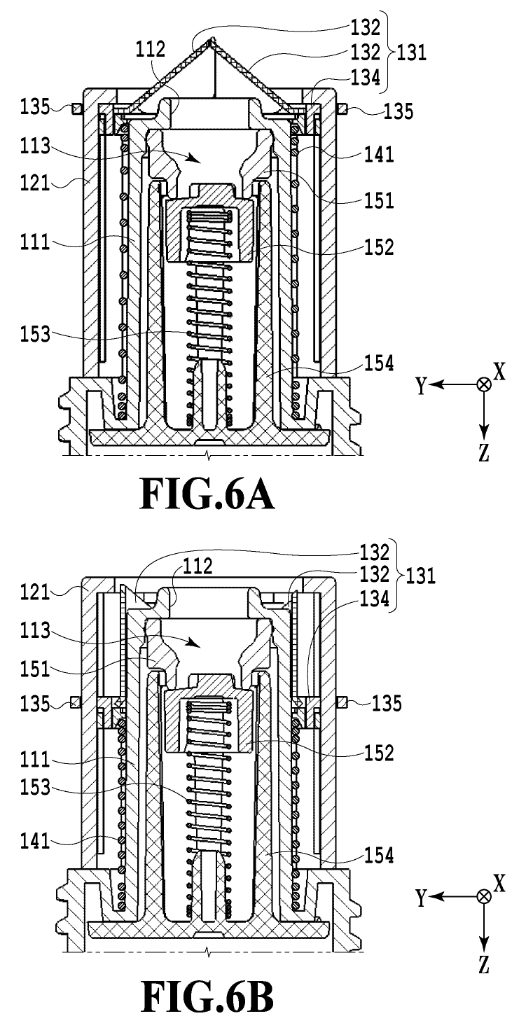

Next, a first embodiment of the liquid container will be described. FIG. 4 is a side view illustrating an outer appearance of the liquid container 100 according to the first embodiment. As illustrated in FIG. 4, the liquid container 100 according to the first embodiment includes a bottle 101, a nozzle 111, an outer frame 121, a shutter 131, and a shutter biasing member 141 (see FIG. 6A to be described later). The liquid container 100 is a liquid container to be connected to a liquid tank 12 of the liquid ejection apparatus 1 to refill it with an ink. Incidentally, in FIGS. 4-7, the direction toward the top of the liquid container 100 in an orientation in which it is connected to the liquid tank 12 is the +Z direction.

The bottle 101 is a liquid storage portion for storing an ink (liquid) therein. The bottle 101 is formed in a tubular box shape extending in the vertical direction (Z direction). The nozzle 111 is coupled to the tip side of the bottle 101. The nozzle 111 is formed in a tubular shape extending in the vertical direction (Z direction). At a tip portion of the nozzle 111, the outlet port 112 (see FIG. 5 to be described later) through which to refill the liquid tank 12 with the ink stored in the bottle 101 is formed. On the inside of the nozzle 111, a liquid channel 113 (see FIG. 6A to be described later) connected to the outlet port 112 is formed. The liquid channel 113 communicates with the inside of the bottle 101 and the outside of the liquid container 100 (bottle 101).

FIG. 5 is a perspective view illustrating the tip side of the liquid container 100 with the shutter 131 exposing the outlet port 112. FIGS. 6A and 6B are side cross-sectional views illustrating the tip side of the liquid container 100. FIG. 6A is a side cross-sectional view illustrating the tip side of the liquid container 100 with the shutter 131 covering the outlet port 112. FIG. 6B is a side cross-sectional view illustrating the tip side of the liquid container 100 with the shutter 131 exposing the outlet port 112.

As illustrated in FIGS. 5 and 6A, the outer frame 121 is formed in a frame shape surrounding the tip side of the nozzle 111. The outer frame 121 is attached to the tip side of the nozzle 111. In side portions of the outer frame 121, groove portions 122 are formed extending along the direction of extension of the nozzle 111 (outer frame 121) (Z direction). The shutter 131 is attached to the outer frame 121.

As illustrated in FIGS. 6A and 6B, the shutter 131 includes two shutter members 132 and 132 and a holding member 134. Each shutter member 132 is formed in a plate shape curved along an outer peripheral portion of the tip side of the nozzle 111. The holding member 134 is formed in a ring shape extending along the outer peripheral portion of the tip side of the nozzle 111. The holding member 134 rotatably holds each shutter member 132. On an outer peripheral portion of the holding member 134, engagement portions 135 that slidably engage with side portions of the outer frame 121 are formed. Also, one end of the shutter biasing member 141 abuts the holding member 134. The other end of the shutter biasing member 141 abuts the base side of the nozzle 111. In this way, the shutter 131 can move to a first position at which it covers the outlet port 112 (see FIG. 6A) and a second position at which it exposes the outlet port 112 (see FIG. 6B).

In a case where the shutter 131 moves to the first position, the holding member 134 moves to the tip side of the nozzle 111 and a base portion of each shutter member 132 comes into abutment with the inner side of a tip portion of the outer frame 121. As a result, the two shutter members 132 and 132 rotationally move in such directions as to approach each other. Finally, the two shutter members 132 and 132 engage into a conical shape, covering the outlet port 112. In a case where the shutter 131 moves toward the second position, the holding member 134 moves to the base side of the nozzle 111, and each shutter member 132 comes into sliding contact with the outer peripheral portion of the nozzle 111. As a result, the two shutter members 132 and 132 rotationally move in such directions as to move away from each other. Then, at the gap portion between the outer frame 121 and the nozzle 111, the two shutter members 132 and 132 get separated from each other, thereby exposing the outlet port 112. Note that, in the state where the two shutter members 132 and 132 are engaged into a conical shape, edge portions of the two shutter members 132 and 132 overlap each other. This prevents or reduces inward deformation of each shutter member 132 even in a case where an external force is applied to the two shutter members 132 and 132.

The shutter biasing member 141 exerts a biasing force that moves the shutter 131 from the second position to the first position. The shutter biasing member 141 is formed using a coil spring, for example. The shutter biasing member 141 is also called a shutter spring. The shutter biasing member 141 is attached to the outer peripheral portion of the tip side of the nozzle 111.

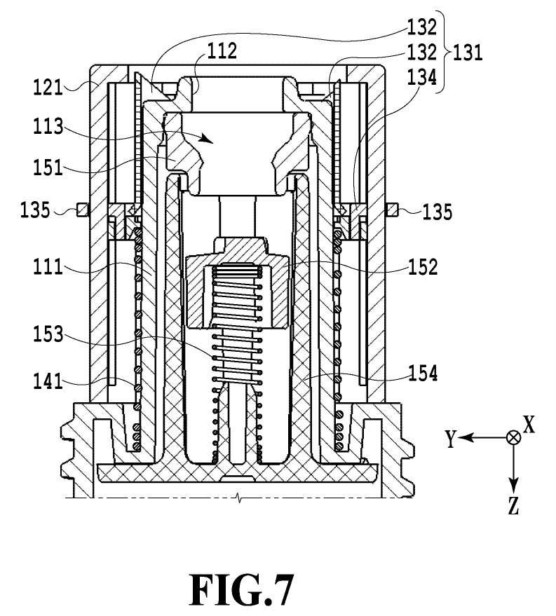

FIG. 7 is a side cross-sectional view illustrating the tip side of the liquid container 100 with the liquid channel 113 opened. As illustrated in FIGS. 6A, 6B, and 7, a seal 151, a valve 152, a valve biasing member 153, and a holder 154 are provided inside the nozzle 111. A valve mechanism configured of the seal 151, the valve 152, the valve biasing member 153, and the holder 154 prevents the ink stored in the bottle 101 from leaking out from the outlet port 112.

The seal 151 is formed in a tubular shape having an outer diameter similar to the inner diameter of the tip side of the nozzle 111. The seal 151 is fit and attached to an inner peripheral portion of the tip side of the nozzle 111. The seal 151 forms part of the liquid channel 113, through which the ink flows.

The valve 152 is formed in a cylindrical shape capable of opening and closing an opening portion of the seal 151. The valve 152 is capable of moving to a third position (see FIGS. 6A and 6B) at which it closes the liquid channel 113 and a fourth position (see FIG. 7) at which it opens the liquid channel 113 by a linear motion along the direction of extension of the nozzle 111 (Z direction). As the valve 152 moves to the third position, it comes into abutment with an edge portion of the seal 151, thereby closing the liquid channel 113. As the valve 152 moves to the fourth position, it gets separated from the seal 151, thereby opening the liquid channel 113. One end of the valve biasing member 153 abuts the valve 152.

The valve biasing member 153 exerts a biasing force that moves the valve 152 from the fourth position to the third position. The valve biasing member 153 is formed using a coil spring, for example. The valve biasing member 153 is also called a valve spring. The valve biasing member 153 is attached between the valve 152 and the holder 154.

The holder 154 is formed in a tubular shape capable of receiving the valve 152 and the valve biasing member 153. The holder 154 is attached to the inner peripheral portion of the tip side of the nozzle 111 in such a way as to be adjacent to the seal 151. The holder 154 forms part of the liquid channel 113, through which the ink flows. The holder 154 holds the valve biasing member 153 such that the valve biasing member 153 can expand and contract along the direction of extension of the nozzle 111 (holder 154) (Z direction). The other end of the valve biasing member 153 (the end on the opposite side from the valve 152) abuts the bottom of the holder 154.

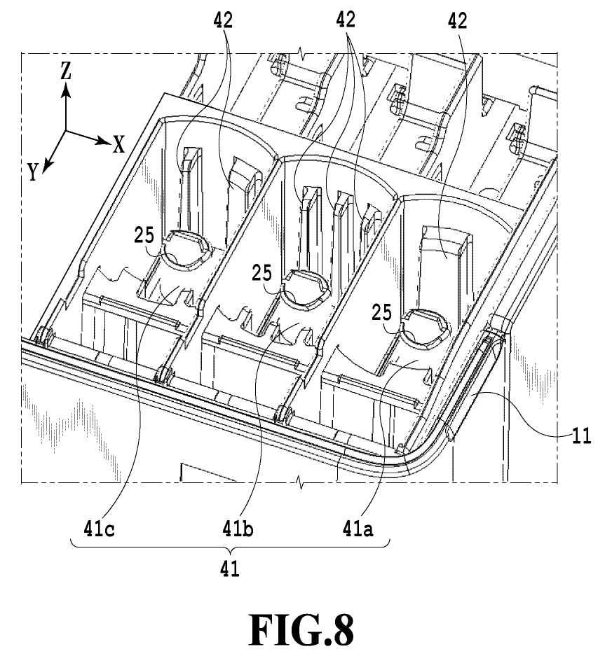

The nozzle 111 and the outer frame 121 are to be inserted into a connection hole portion 41 (see FIG. 8) provided above a liquid tank 12 inside the housing 11. The liquid container 100 is connected to the liquid tank 12 of the liquid ejection apparatus 1 in the state where the nozzle 111 and the outer frame 121 are inserted in the connection hole portion 41.

FIG. 8 is a schematic view illustrating an example of the connection hole portions 41 of the liquid ejection apparatus 1. The connection hole portions 41 are each formed in a hole shape conforming to the shape of the outer periphery of the outer frame 121. Four connection hole portions for the four types of inks (liquid containers 100) are provided as the connection hole portions 41. For example, a connection hole portion 41a for the cyan ink is formed around the inlet port 25 of the liquid tank 12a for the cyan ink. A connection hole portion 41b for the magenta ink is formed around the inlet port 25 of the liquid tank 12b for the magenta ink. A connection hole portion 41c for the yellow ink is formed around the inlet port 25 of the liquid tank 12c for the yellow ink. A connection hole portion for the black ink (not illustrated) is formed around the inlet port 25 of the liquid tank 12d for the black ink.

Convex portions 42 extending in the vertical direction (Z direction) are formed on inner wall portions of each connection hole portion 41. The convex portions 42 engage with the groove portions 122 of the outer frame 121. In a case where the convex portions 42 engage with the groove portions 122, the convex portions 42 abut the holding member 134 of the shutter 131. The shape of the convex portions 42 varies from one connection hole portion 41 to another. In a case of connecting the liquid container 100 to a specific liquid tank among the four liquid tanks 12a to 12d, the convex portions 42 engage with the groove portions 122 and come into abutment with the holding member 134. As a result, the shutter 131 moves to the second position, and the valve 152 opens the liquid channel 113. In a case of connecting the liquid container 100 to a liquid tank among the four liquid tanks 12a to 12d other than the specific liquid tank, the convex portions 42 fail to engage with the groove portions 122. This restricts movement of the shutter 131 to the second position and restricts opening of the liquid channel 113 by the valve 152.

In this way, the liquid container 100 is connected only to a specific liquid tank 12 in the liquid ejection apparatus 1. For example, the nozzle and outer frame of a liquid container for the cyan ink can be inserted only into the connection hole portion 41a for the cyan ink. In this way, the liquid container for the cyan ink will be connected only to the liquid tank 12a for the cyan ink. The nozzle and outer frame of a liquid container for the magenta ink can be inserted only into the connection hole portion 41b for the magenta ink. In this way, the liquid container for the magenta ink will be connected only to the liquid tank 12b for the magenta ink. The nozzle and outer frame of a liquid container for the yellow ink can be inserted only into the connection hole portion 41c for the yellow ink. In this way, the liquid container for the yellow ink will be connected only to the liquid tank 12c for the yellow ink. The nozzle and outer frame of a liquid container for the black ink can be inserted only into the connection hole portion for the black ink. In this way, the liquid container for the black ink will be connected only to the liquid tank 12d for the black ink.

### Connecting Liquid Container

Next, a series of operations for connecting the liquid container 100 to a liquid tank 12 of the liquid ejection apparatus 1 will be described. FIG. 6A illustrates a state of the liquid container 100 before being connected to the liquid tank 12, i.e., a normal state of the liquid container 100. In the normal state, the shutter 131 of the liquid container 100 is moved to the first position by the biasing force from the shutter biasing member 141. As the shutter 131 is moved to the first position, the holding member 134 moves to the tip side of the nozzle 111 and the base portion of each shutter member 132 comes into abutment with the inner side of the tip portion of the outer frame 121. As a result, the two shutter members 132 and 132 rotationally move in such directions as to approach each other. Finally, the two shutter members 132 and 132 engage into a conical shape, covering the outlet port 112. Also, the valve 152 of the liquid container 100 is moved to the third position by the biasing force from the valve biasing member 153, thereby closing the liquid channel 113 inside the nozzle 111.

Thus, the two shutter members 132 and 132 covering the outlet port 112 prevent the user's hand or the like from touching the tip of the nozzle 111 (outlet port 112). Also, the valve 152 closing the liquid channel 113 prevents the ink stored in the bottle 101 from leaking out from the outlet port 112. In the state where the two shutter members 132 and 132 are engaged into a conical shape, the edge portions of the two shutter members 132 and 132 overlap each other. This prevents or reduces inward deformation of each shutter member 132 even in a case where an external force is applied to the two shutter members 132 and 132.

FIG. 6B illustrates the state of the liquid container 100 in the process of being connected to the liquid tank 12, i.e., a state during connection of the liquid container 100. In a case of connecting the liquid container 100 to a liquid tank 12, the user inserts the nozzle 111 and the outer frame 121 into the connection hole portion 41 (see FIG. 8) of the liquid ejection apparatus 1. In a case of connecting the liquid container 100 to a specific liquid tank among the four liquid tanks 12a to 12d, the convex portions 42 of the connection hole portion 41 engage with the groove portions 122 of the outer frame 121 and come into abutment with the holding member 134 of the shutter 131. In response to the convex portions 42 coming into abutment with the holding member 134, the shutter 131 moves from the first position toward the second position against the biasing force from the shutter biasing member 141. As the shutter 131 moves toward the second position, the holding member 134 moves to the base side of the nozzle 111, and each shutter member 132 comes into sliding contact with the outer peripheral portion of the nozzle 111. As a result, the two shutter members 132 and 132 rotationally move in such directions as to move away from each other. Then, at the gap portion between the outer frame 121 and the nozzle 111, the two shutter members 132 and 132 get separated from each other, thereby exposing the outlet port 112. The specific liquid tank can now be refilled with the ink stored in the bottle 101. Note that, in the state during connection of the liquid container 100, the liquid channel 113 is closed by the valve 152, thereby preventing the ink stored in the bottle 101 from leaking out from the outlet port 112.

Also, in a case of connecting the liquid container 100 to a liquid tank among the four liquid tanks 12a to 12d other than the specific liquid tank, the convex portions 42 of the connection hole portion 41 fail to engage with the groove portions 122. This restricts movement of the shutter 131 to the second position and restricts opening of the liquid channel 113 by the valve 152.

FIG. 7 illustrates a connected state in which the liquid container 100 is connected to a liquid tank 12. The user moves the liquid container 100 in the -Z direction with the nozzle 111 and the outer frame 121 inserted in the connection hole portion 41 (see FIG. 8) of the liquid ejection apparatus 1. At this time, the shutter 131 moves to the second position against the biasing force from the shutter biasing member 141. Also, the communication channel portion 22 (not illustrated in FIG. 7) of the liquid tank 12 is inserted into the liquid channel 113 through the outlet port 112 of the nozzle 111 and comes into abutment with the valve 152. In response to the tip portion of the communication channel portion 22 (inlet port 25) coming into abutment with the valve 152, the valve 152 moves from the third position to the fourth position against the biasing force from the valve biasing member 153. As the valve 152 moves to the fourth position, it gets separated from the seal 151, thereby opening the liquid channel 113. The liquid container 100 is connected to the liquid tank 12 in this manner. With the valve 152 opening the liquid channel 113, the communication channel portion 22 of the liquid tank 12 and the liquid channel 113 communicate with each other. Accordingly, the ink stored in the bottle 101 flows through the liquid channel 113, the inlet port 25, and the communication channel portion 22 and refills the liquid tank main body 21 (liquid chamber) under the action of gravity.

In a case of separating the liquid container 100 from the liquid tank 12, the user pulls the nozzle 111 and the outer frame 121 out of the connection hole portion 41 of the liquid ejection apparatus 1. As a result, the communication channel portion 22 of the liquid tank 12 is pulled out of the liquid channel 113 and the outlet port 112 of the nozzle 111. Also, the convex portions 42 of the connection hole portion 41 and the groove portions 122 of the outer frame 121 are disengaged from each other. At this time, the valve 152 moves to the third position with the biasing force from the valve biasing member 153, thereby closing the liquid channel 113 inside the nozzle 111. The shutter 131 moves to the first position with the biasing force from the shutter biasing member 141. As the shutter 131 moves to the first position, the holding member 134 moves to the tip side of the nozzle 111 and the base portion of each shutter member 132 comes into abutment with the inner side of the tip portion of the outer frame 121. As a result, the two shutter members 132 and 132 rotationally move in such directions as to approach each other. Finally, the two shutter members 132 and 132 engage into a conical shape, covering the outlet port 112. The liquid container 100 returns to the state before it was to the liquid tank 12 in this manner.

In this way, the outlet port 112 of the nozzle 111 is exposed and the liquid channel 113 inside the nozzle 111 is opened only in a state where the liquid container 100 is connected to the liquid tank 12. In the normal state, the shutter 131 covers the outlet port 112, thereby keeping the user's hand or the like from touching the ink in the outlet port 112 and thus preventing the ink from getting attached to and soiling the user's hand or the like. Also, the valve 152 closes the liquid channel 113, thereby keeping the ink stored in the bottle 101 from leaking out from the outlet port 112 and thus preventing the ink from spurting out and causing soiling when the shutter 131 exposes the outlet port 112. Accordingly, it is possible to provide a liquid container 100 that does not cause soiling.

As described above, according to the first embodiment, it is possible to provide a liquid container 100 that does not cause soiling. Specifically, in the present embodiment, the shutter 131 provided in the outer frame 121 is capable of moving to the first position, at which it covers the outlet port 112 of the nozzle 111, and the second position, at which it exposes the outlet port 112. The valve 152 provided inside the nozzle 111 is capable of opening and closing the liquid channel 113 connected to the outlet port 112. In a case where the liquid container 100 is connected to the liquid ejection apparatus 1, the shutter 131 moves to the second position to expose the outlet port 112, and the valve 152 opens the liquid channel 113. In the normal state, the shutter 131 covers the outlet port 112, thereby keeping the user's hand or the like from touching the ink in the outlet port 112 and thus preventing the ink from getting attached to and soiling the user's hand or the like. Also, the valve 152 closes the liquid channel 113, thereby keeping the ink stored in the bottle 101 from leaking out from the outlet port 112 and thus preventing the ink from spurting out and causing soiling when the shutter 131 exposes the outlet port 112. Accordingly, it is possible to provide a liquid container 100 that does not cause soiling.

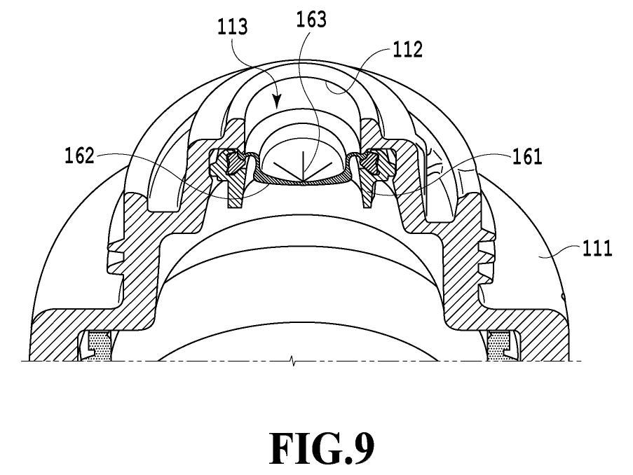

In the above-described first embodiment, a valve mechanism configured of the seal 151, the valve 152, the valve biasing member 153, and the holder 154 is provided, but the present disclosure is not limited to this. FIG. 9 is a perspective view illustrating a modification of the liquid container according to the first embodiment. As illustrated in FIG. 9, a seal 161 and a valve 162 having slits 163 may be provided inside the nozzle 111. A valve mechanism configured of the seal 161 and the valve 162 can prevent the ink stored in the bottle 101 from leaking out from the outlet port 112. The valve 162 in the modification is formed in a film shape using an elastic resin material, such as rubber, and joined to the inner side of the seal 161.

In the normal state, the valve 162 closes the slits 163 to thereby close the liquid channel 113 inside the nozzle 111. In a case of connecting the liquid container 100 to a liquid tank 12, the communication channel portion 22 (not illustrated in FIG. 9) of the liquid tank 12 is inserted into the liquid channel 113 from the outlet port 112 of the nozzle 111 and comes into abutment with the valve 162. In response to the tip portion of the communication channel portion 22 (inlet port 25) coming into abutment with the valve 162, the valve 162 becomes elastically deformed to open the slits 163 and thereby open the liquid channel 113.

In the above-described first embodiment, the shutter 131 includes two shutter members 132 and 132, but the present disclosure is not limited to this. The shutter in the first embodiment may include three shutter members, and it suffices that the shutter includes multiple shutter members. It suffices that the multiple shutter members engage with each other to cover the outlet port 112 in a case where the shutter moves to the first position. It suffices that the multiple shutter members get separated from each other to expose the outlet port 112 in a case where the shutter moves to the second position.

### Second Embodiment

Next, a second embodiment of a liquid container will be described. Some members in the second embodiment have similar configurations to those in the above-described first embodiment. Thus, the description will be given with the same reference signs given to these members as those in the above-described first embodiment.

### Configuration of Liquid Container

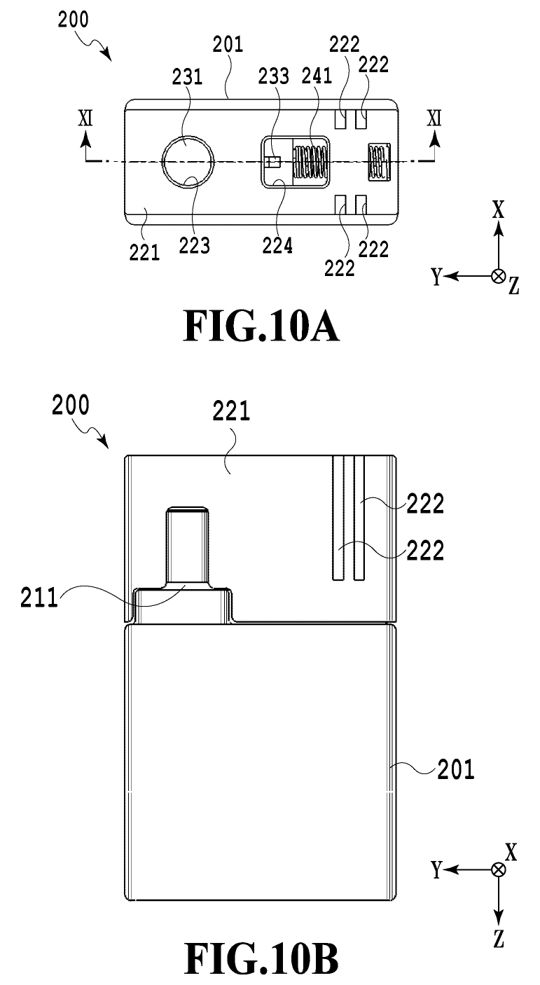

FIGS. 10A and 10B are views illustrating an outer appearance of a liquid container 200 according to the second embodiment. FIG. 10A is a plan view illustrating an outer appearance of the liquid container 200 according to the second embodiment. FIG. 10B is a side view illustrating an outer appearance of the liquid container 200 according to the second embodiment. As illustrated in FIGS. 10A and 10B, the liquid container 200 according to the second embodiment includes a bottle 201, a nozzle 211, an outer frame 221, a shutter 231, and a shutter biasing member 241. The liquid container 200 is a liquid container to be connected to a liquid tank 12 of the liquid ejection apparatus 1 to refill it with an ink. Incidentally, in FIGS. 10A-12B, the direction toward the top of the liquid container 200 in an orientation in which it is connected to the liquid tank 12 is the +Z direction.

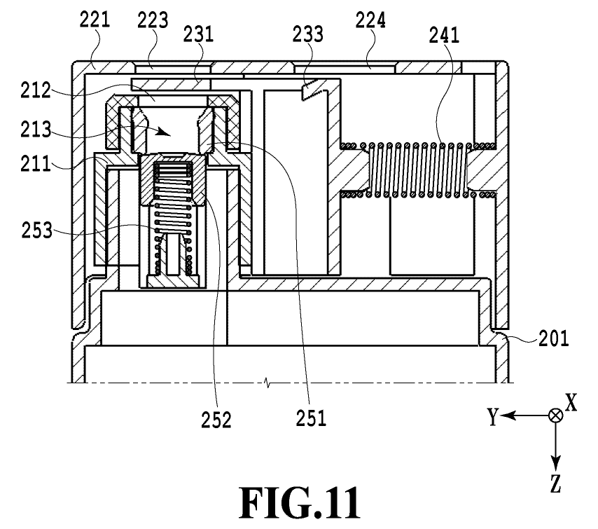

The bottle 201 is a liquid storage portion for storing an ink (liquid) therein. The bottle 201 is formed in a rectangular box shape extending in the vertical direction (Z direction). The nozzle 211 is coupled to the tip side of the bottle 201. The nozzle 211 is formed in a tubular shape extending in the vertical direction (Z direction). At a tip portion of the nozzle 211, an outlet port 212 (see FIG. 11 to be described later) through which to refill the liquid tank 12 with the ink stored in the bottle 201 is formed. On the inside of the nozzle 211, a liquid channel 213 (see FIG. 11 to be described later) connected to the outlet port 212 is formed. The liquid channel 213 communicates with the inside of the bottle 201 and the outside of the liquid container 200 (bottle 201).

FIG. 11 is a cross-sectional view taken along the line XI-XI in FIG. 10A. As illustrated in FIG. 11, the outer frame 221 is formed in a frame shape surrounding the tip side of the nozzle 211. The outer frame 221 is attached to the tip side of the nozzle 211. In side portions of the outer frame 221, concave portions 222 are formed extending along the direction of extension of the nozzle 211 (Z direction). At a tip portion of the outer frame 221, an insertion hole 223 is formed at a position matching that of the outlet port 212. Also, at the tip portion of the outer frame 221, a slot 224 is formed at a position matching that of a cam abutment portion 233 of the shutter 231. The shutter 231 is attached to the inside of the outer frame 221.

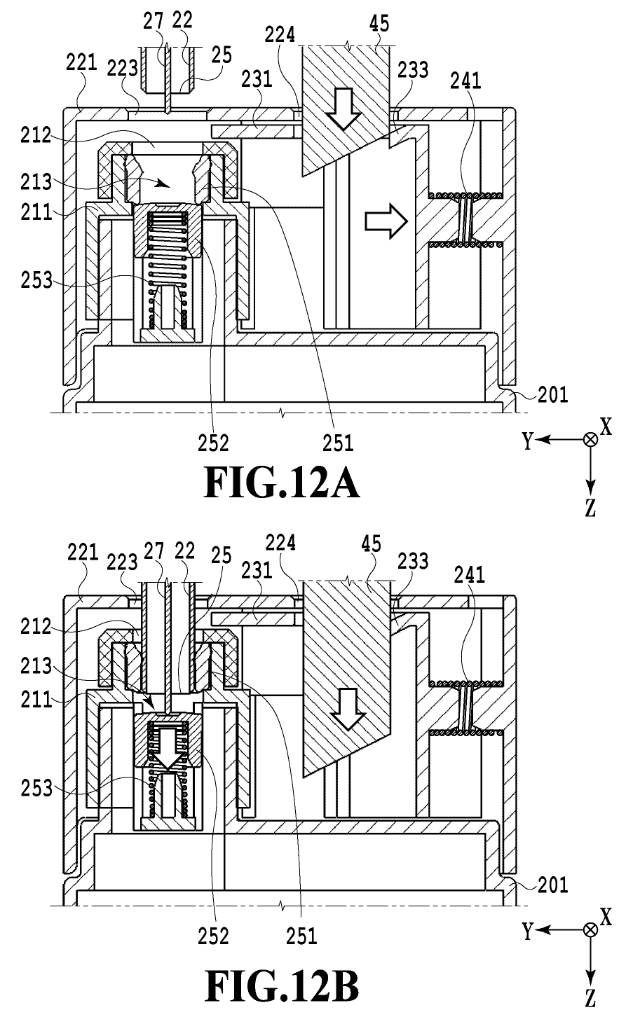

FIGS. 12A and 12B are side cross-sectional views illustrating the tip side of the liquid container 200 according to the second embodiment. FIG. 12A is a side cross-sectional view illustrating the tip side of the liquid container 200 with the shutter 231 exposing the outlet port 212. FIG. 12B is a side cross-sectional view illustrating the tip side of the liquid container 200 with the liquid channel 213 opened.

As illustrated in FIGS. 11 and 12A, the shutter 231 is formed in a plate shape extending along a direction (Y direction) intersecting the direction of extension of the nozzle 211 (Z direction). The cam abutment portion 233 is formed on the base side of the shutter 231. The cam abutment portion 233 is capable of abutting a cam plate 45 of the liquid ejection apparatus 1. Also, one end of the shutter biasing member 241 abuts a base portion of the shutter 231. The other end of the shutter biasing member 241 abuts an inner wall portion of the outer frame 221. This enables the shutter 231 to move to a first position at which it covers the outlet port 212 (see FIG. 11) and a second position at which it exposes the outlet port 212 through the insertion hole 223 of the outer frame 221 (see FIG. 12A). The shutter 231 in the second embodiment is capable of moving to the first position and the second position by a linear motion along a direction (Y direction) intersecting the direction of extension of the nozzle 211 (Z direction).

The shutter biasing member 241 exerts a biasing force that moves the shutter 231 from the second position to the first position. The shutter biasing member 241 is formed using a coil spring, for example. The shutter biasing member 241 is also called a shutter spring. The shutter biasing member 241 is attached between the base portion of the shutter 231 and the inner wall portion of the outer frame 221.

As illustrated in FIGS. 12A and 12B, a seal 251, a valve 252, and a valve biasing member 253 are provided inside the nozzle 211. A valve mechanism configured of the seal 251, the valve 252, and the valve biasing member 253 prevents the ink stored in the bottle 201 from leaking out from the outlet port 212.

The seal 251 is formed in a tubular shape having an outer diameter similar to the inner diameter of the tip side of the nozzle 211. The seal 251 is fit and attached to an inner peripheral portion of the tip side of the nozzle 211. The seal 251 forms part of the liquid channel 213, through which the ink flows.

The valve 252 is formed in a cylindrical shape capable of opening and closing an opening portion of the seal 251. The valve 252 is capable of moving to a third position (see FIG. 12A) at which it closes the liquid channel 213 and a fourth position (see FIG. 12B) at which it opens the liquid channel 213 by a linear motion along the direction of extension of the nozzle 211 (Z direction). As the valve 252 moves to the third position, it comes into abutment with an edge portion of the seal 251, thereby closing the liquid channel 213. As the valve 252 moves to the fourth position, it gets separated from the seal 251, thereby opening the liquid channel 213. One end of the valve biasing member 253 abuts the valve 252. The other end of the valve biasing member 253 abuts the tip side of the bottle 201.

The valve biasing member 253 exerts a biasing force that moves the valve 252 from the fourth position to the third position. The valve biasing member 253 is formed using a coil spring, for example. The valve biasing member 253 is also called a valve spring. The valve biasing member 253 is attached between the valve 252 and the bottle 201.

The nozzle 211 and the outer frame 221 are to be inserted into one of connection hole portions (not illustrated) provided above the liquid tanks 12 inside the housing 11. The liquid container 200 is connected to a liquid tank 12 of the liquid ejection apparatus 1 in the state where the nozzle 211 and the outer frame 221 are inserted in the corresponding connection hole portion.

While not illustrated, the connection hole portions are each formed in a hole shape conforming to the shape of the outer periphery of the outer frame 221. As in the first embodiment, as the connection hole portions, four connection hole portions for the four types of inks (liquid containers 200) are provided. Convex portions (not illustrated) extending in the vertical direction (Z direction) are formed on inner wall portions of each connection hole portion. Also, a cam plate 45 (see FIG. 12B) protruding in the vertical direction (Z direction) is formed on the bottom of each connection hole portion. The convex portions engage with the concave portions 222 of the outer frame 221. In a case where the convex portions engage with the concave portions 222, the cam abutment portion 233 of the shutter 231 comes into abutment with the cam plate 45.

As in the first embodiment, the shape of the convex portions varies from one connection hole portion to another. In a case of connecting the liquid container 200 to a specific liquid tank among the four liquid tanks 12a to 12d, the concave portions 222 of the outer frame 221 engage with the convex portions and the cam abutment portion 233 of the shutter 231 comes into abutment with the cam plate 45. As a result, the shutter 231 moves to the second position with the cam abutment portion 233 in abutment with the cam plate 45, and the valve 252 opens the liquid channel 213. In a case of connecting the liquid container 200 to a liquid tank among the four liquid tanks 12a to 12d other than the specific liquid tank, the concave portions 222 of the outer frame 221 fail to engage with the convex portions, so that the cam abutment portion 233 of the shutter 231 does not come into abutment with the cam plate 45. This restricts movement of the shutter 231 to the second position and restricts opening of the liquid channel 213 by the valve 252. In this way, as in the first embodiment, the liquid container 200 is connected only to a specific liquid tank 12 in the liquid ejection apparatus 1.

### Connecting Liquid Container

Next, a series of operations for connecting the liquid container 200 to a liquid tank 12 of the liquid ejection apparatus 1 will be described. FIG. 11 illustrates the liquid container 200 in a normal state. In the normal state, the shutter 231 of the liquid container 200 is moved to the first position by the biasing force from the shutter biasing member 241, thereby covering the outlet port 212 of the nozzle 211. Also, the valve 252 of the liquid container 200 is moved to the third position by the biasing force from the valve biasing member 253, thereby closing the liquid channel 213 inside the nozzle 211.

Thus, the shutter 231 covering the outlet port 212 prevents the user's hand or the like from touching the tip of the nozzle 211 (outlet port 212). Also, the valve 252 closing the liquid channel 213 prevents the ink stored in the bottle 201 from leaking out from the outlet port 212.

FIG. 12A illustrates a state during connection of the liquid container 200. In a case of connecting the liquid container 200 to a liquid tank 12, the user inserts the nozzle 211 and the outer frame 221 into the connection hole portion (not illustrated) of the liquid ejection apparatus 1. In a case of connecting the liquid container 200 to the specific liquid tank among the four liquid tanks 12a to 12d, the convex portions of the connection hole portion engage with the concave portions 222 of the outer frame 221. As the convex portions engage with the concave portions 222, the cam plate 45 in the connection hole portion passes through the slot 224 in the outer frame 221 and comes into contact with the cam abutment portion 233 of the shutter 231. With the cam abutment portion 233 in abutment with the inclined surface of the cam plate 45, the shutter 231 moves from the first position to the second position against the biasing force from the shutter biasing member 241. As the shutter 231 moves to the second position, the outlet port 212 becomes exposed through the insertion hole 223 in the outer frame 221. The specific liquid tank can now be refilled with the ink stored in the bottle 201. Note that, in the state during connection of the liquid container 200, the liquid channel 213 is closed by the valve 252, thereby preventing the ink stored in the bottle 201 from leaking out from the outlet port 212.

Also, in a case of connecting the liquid container 200 to a liquid tank among the four liquid tanks 12a to 12d other than the specific liquid tank, the convex portions of the connection hole portion fail to engage with the concave portions 222. This restricts movement of the shutter 231 to the second position and restricts opening of the liquid channel 213 by the valve 252.

FIG. 12B illustrates a connected state in which the liquid container 200 is connected to a liquid tank 12. The user moves the liquid container 200 in the -Z direction with the nozzle 211 and the outer frame 221 inserted in the connection hole portion (not illustrated) of the liquid ejection apparatus 1. At this time, with the cam abutment portion 233 in abutment with the flat surface of the cam plate 45, the shutter 231 remains at the second position. Also, the communication channel portion 22 of the liquid tank 12 is inserted through the insertion hole 223 in the outer frame 221 and inserted into the liquid channel 213 from the outlet port 212 of the nozzle 211. The communication channel portion 22 of the liquid tank 12 comes into abutment with the valve 252 as it is inserted into the liquid channel 213. Incidentally, the inside of the communication channel portion 22 and the inlet port 25 may be partitioned by a partition member 27. In this case, a tip portion of the partition member 27 may come into abutment with the valve 252. In response to the tip portion of the communication channel portion 22 (or the partition member 27) coming into abutment with the valve 252, the valve 252 moves from the third position to the fourth position against the biasing force from the valve biasing member 253. As the valve 252 moves to the fourth position, it gets separated from the seal 251, thereby opening the liquid channel 213. The liquid container 200 is connected to the liquid tank 12 in this manner. With the valve 252 opening the liquid channel 213, the communication channel portion 22 of the liquid tank 12 and the liquid channel 213 communicate with each other. Accordingly, the ink stored in the bottle 201 flows through the liquid channel 213, the inlet port 25, and the communication channel portion 22 and refills the liquid tank main body 21 (liquid chamber) under the action of gravity.

In a case of separating the liquid container 200 from the liquid tank 12, the user pulls the nozzle 211 and the outer frame 221 out of the connection hole portion of the liquid ejection apparatus 1. As a result, the communication channel portion 22 of the liquid tank 12 is pulled out of the liquid channel 213 and the outlet port 212 of the nozzle 211, and also pulled out of the insertion hole 223 in the outer frame 221. Also, the convex portions of the connection hole portion and the concave portions 222 of the outer frame 221 are disengaged from each other, and the cam plate 45 in the connection hole portion is pulled out of the slot 224 in the outer frame 221. At this time, the valve 252 moves to the third position with the biasing force from the valve biasing member 253, thereby closing the liquid channel 213 inside the nozzle 211. The shutter 231 moves to the first position with the biasing force from the shutter biasing member 241, thereby covering the outlet port 212 of the nozzle 211. The liquid container 200 returns to the state before it was to the liquid tank 12 in this manner.

In this way, the outlet port 212 of the nozzle 211 is exposed and the liquid channel 213 inside the nozzle 211 is opened only in a state where the liquid container 200 is connected to the liquid tank 12. In the normal state, the shutter 231 covers the outlet port 212, thereby keeping the user's hand or the like from touching the ink in the outlet port 212 and thus preventing the ink from getting attached to and soiling the user's hand or the like. Also, the valve 252 closes the liquid channel 213, thereby keeping the ink stored in the bottle 201 from leaking out from the outlet port 212 and thus preventing the ink from spurting out and causing soiling when the shutter 231 exposes the outlet port 212. Accordingly, it is possible to provide a liquid container 200 that does not cause soiling.

As described above, according to the second embodiment, it is possible to provide a liquid container 200 that does not cause soiling, as in the first embodiment.

In the above-described second embodiment, a valve mechanism configured of the seal 251, the valve 252, and the valve biasing member 253 is provided, but the present disclosure is not limited to this. For example, as in the modification of the liquid container according to the first embodiment, a seal and a valve having slits may be provided inside the nozzle 111. A valve mechanism configured of the seal and the valve also prevents the ink stored in the bottle 101 from leaking out from the outlet port 112.

In the above-described second embodiment, the cam abutment portion 233 of the shutter 231 is capable of abutting the cam plate 45 in the connection hole portion, but the present disclosure is not limited to this. For example, the convex portions of the connection hole portion may have inclined surfaces capable of abutting the cam abutment portion of the shutter 231. In a case of connecting the liquid container 200 to the specific liquid tank among the four liquid tanks 12a to 12d, the convex portions of the connection hole portion may engage with the concave portions 222 of the outer frame 221 and come into abutment with the cam abutment portion of the shutter 231. In this way, the shutter 231 can move from the first position to the second position against the biasing force from the shutter biasing member 241 with the cam abutment portion in abutment with the inclined surfaces of the convex portions. Also, the shutter 231 can remain at the second position with the cam abutment portion in abutment with the flat surfaces of the convex portions.

In each of the above-described embodiments, the four liquid tanks 12a to 12d for four types of inks are provided as the liquid tanks 12, but the present disclosure is not limited to this. For example, the liquid ejection apparatus may be provided with three liquid tanks for three types of inks or provided with five liquid tanks for five types of inks. The liquid ejection apparatus may be provided with multiple liquid tanks or provided with a single liquid tank.

In each of the above-described embodiments, the liquid ejection apparatus 1 is a serial inkjet printing apparatus, but the present disclosure is not limited to this. For example, the liquid ejection apparatus may be a full-line inkjet printing apparatus capable of ejecting inks over an entire print medium in the width direction without main scanning.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to provide a liquid container that does not cause soiling.

This application claims the benefit of priority from Japanese Patent Application No. 2025-038334, filed Mar. 11, 2025, which is hereby incorporated by reference herein in its entirety.

What is claimed is:

1. A liquid container to be connected to a liquid ejection apparatus to refill the liquid ejection apparatus with a liquid, the liquid container comprising:
a liquid storage portion configured to store a liquid inside;
a nozzle having an outlet port for refilling the liquid ejection apparatus with the liquid stored in the liquid storage portion;
an outer frame surrounding a tip side of the nozzle where the outlet port is formed;
a shutter provided to the outer frame and capable of moving to a first position at which the shutter covers the outlet port and a second position at which the shutter exposes the outlet port; and
a valve provided inside the nozzle and capable of opening and closing a liquid channel connected to the outlet port, wherein
in a case of connecting the liquid container to the liquid ejection apparatus, the shutter moves to the second position and the valve opens the liquid channel.

2. The liquid container according to claim 1, further comprising a shutter biasing member configured to exert a biasing force that moves the shutter from the second position to the first position, wherein
in a case of connecting the liquid container to the liquid ejection apparatus, the shutter moves from the first position to the second position against the biasing force from the shutter biasing member.

3. The liquid container according to claim 2, wherein the shutter biasing member is formed using a coil spring.

4. The liquid container according to claim 1, wherein in a case of connecting the liquid container to a specific liquid tank among a plurality of liquid tanks of the liquid ejection apparatus, the shutter moves to the second position and the valve opens the liquid channel.

5. The liquid container according to claim 4, wherein in a case of connecting the liquid container to a liquid tank among the plurality of liquid tanks other than the specific liquid tank, movement of the shutter to the second position is restricted and opening of the liquid channel by the valve is restricted.

6. The liquid container according to claim 1, wherein
the shutter includes a plurality of shutter members,
in a case where the shutter moves to the first position, the plurality of shutter members engage with each other to thereby cover the outlet port, and
in a case where the shutter moves to the second position, the plurality of shutter members get separated from each other to thereby expose the outlet port.

7. The liquid container according to claim 6, wherein in a case where the shutter moves to the second position, the plurality of shutter members get separated from each other at a gap portion between the outer frame and the nozzle.

8. The liquid container according to claim 1, wherein the shutter is capable of moving to the first position and the second position by a linear motion along a direction intersecting a direction of extension of the nozzle.

9. The liquid container according to claim 8, wherein
the shutter has a cam abutment portion capable of abutting a cam plate of the liquid ejection apparatus, and
in a case of connecting the liquid container to the liquid ejection apparatus, the shutter moves to the second position by the linear motion with the cam abutment portion in abutment with the cam plate.

10. The liquid container according to claim 1, wherein
the valve is capable of moving to a third position at which the valve closes the liquid channel and a fourth position at which the valve opens the liquid channel,
the liquid container further comprises a valve biasing member configured to exert a biasing force that moves the valve from the fourth position to the third position, and
in a case of connecting the liquid container to the liquid ejection apparatus, the valve moves from the third position to the fourth position against the biasing force from the valve biasing member.

11. The liquid container according to claim 10, wherein the valve biasing member is formed using a coil spring.

12. The liquid container according to claim 10, wherein the valve is capable of moving to the third position and the fourth position by a linear motion along a direction of extension of the nozzle.
